(19) United States
(12) Patent Application Publication
(10) Pub. No.: US 2024/0064466 A1
(43) Pub. Date: Feb. 22, 2024

(54) Sound device

(71) Applicant: AAC Microtech (Changzhou) Co., Ltd., Changzhou City (CN)

(72) Inventors: Yang Shi, Shenzhen (CN); Ronglin Linghu, Shenzhen (CN); Jiasheng Zhou, Shenzhen (CN)

(21) Appl. No.: 18/086,694

(22) Filed: Dec. 22, 2022

Related U.S. Application Data
(63) Continuation of application No. PCT/CN2022/122681, filed on Sep. 29, 2022.

(30) Foreign Application Priority Data
Aug. 19, 2022 (CN) 2022110012226

(51) Int. Cl. H04R 9/02; H04R 7/16

(52) U.S. Cl. CPC H04R 9/025; H04R 7/16

(57) ABSTRACT

The present disclosure discloses a sound device comprising: a frame; a vibration system supported on the frame; a magnetic system driving the vibration system for sound generation supported on the frame; the magnetic system comprises a main magnet, a sub-magnet and a magnetic gap formed by spacing of the main magnet and the sub-magnet; the vibration system includes a diaphragm fixed to the frame and a coil driving the diaphragm for sound generation, the coil is at least partially inserted in the magnetic gap; the coil includes a first coil and a second coil both in a shape of ring, one end of the first coil is fixed to the side of the diaphragm near the magnetic system, one end of the second coil is fixed to the end of the first coil near the magnetic system, and the first coil and the second coil are insulated from each other. The present disclosure provides a sound device with adjustable voice coil position and good acoustic performance.

### FIELD OF THE PRESENT DISCLOSURE

The present disclosure relates to electro-acoustic transducers, especially relates to a sound device applied in electronic speaker products.

### DESCRIPTION OF RELATED ART

As one of the main components of mobile terminals such as cell phones, the sound device is mainly used to convert electrical signals into sound signals, and can also be used for earphones.

The sound device of the related arts comprises a frame, a vibration system fixed to said frame and a magnetic system having a magnetic gap, said vibration system comprising a diaphragm fixed to said frame for vibration sound generation, and a coil inserted in said magnetic gap to drive the vibration of said diaphragm.

However, in the related arts, the coil needs a bracket for support, and the fixed structure of the bracket makes the position of the coil in the magnetic gap cannot be adjusted relative to the magnetic system, which is not conducive to maximizing the BL of the coil in the magnetic system and affecting the sound effect of the sound device.

Therefore, it is necessary to provide an improved sound device to overcome the problems mentioned above.

### SUMMARY OF THE INVENTION

The present disclosure provide a sound device with adjustable coil position to achieve maximum coil BL.

The sound device comprising: a frame; a vibration system supported on the frame; a magnetic system driving the vibration system for sound generation supported on the frame; the magnetic system comprises a main magnet, a sub-magnet and a magnetic gap formed by spacing of the main magnet and the sub-magnet; the vibration system includes a diaphragm fixed to the frame and a coil driving the diaphragm for sound generation, the coil is at least partially inserted in the magnetic gap; the coil includes a first coil and a second coil both in a shape of ring, one end of the first coil is fixed to the side of the diaphragm near the magnetic system, one end of the second coil is fixed to the end of the first coil near the magnetic system, and the first coil and the second coil are insulated from each other.

Further, the first coil and the second coil are wound in one piece to form a structure.

Further, the second coil is formed by continuing coaxial winding at the end of the first coil.

Further, a projection of the second coil in the plane parallel to a vibration direction of the diaphragm is covered by a projection of the main magnet in the plane parallel to the vibration direction of the diaphragm.

Further, a thickness of the first coil is less than a thickness of the second coil along a direction perpendicular to the vibration direction of the diaphragm.

Further, the diaphragm includes a ring-shaped fixing part fixed to the frame, a folded ring part fixed to a inner periphery of the fixing part, and a dome fixed to a inner periphery of the folded ring part, the first coil is fixed to the side of the dome facing the magnetic system.

Further, the sound device comprises a breathable isolator, the magnetic system comprises a magnetic bowl; the magnetic bowl comprises a breathable hole, the breathable isolator covers the breathable hole.

Further, the main magnet and the sub-magnet are fixed to the magnetic bowl.

Compared to related arts, the coil in the sound device of the present disclosure includes a first coil and a second coil, both in the shape of a ring, one end of the first coil is fixed to the side of the diaphragm near the magnetic circuit system, and the second coil is fixed to the end of the first coil near the magnetic circuit system, and the first coil and the second coil are insulated from each other. By using the first coil as a support design for the second coil in place of the conventional bracket structure to facilitate the adjustment of the position of the second coil in the magnetic gap along the vibration direction of the diaphragm by flexibly adjusting the number of turns of the first coil, the BL of second coil is maximized in the magnetic circuit, effectively enhancing the acoustic performance.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is a structure schematic of a sound device of the present disclosure.

FIG. 2 is an exploded view of the sound device of the present disclosure.

FIG. 3 is a cross-sectional view of the sound device taken along line A-A in FIG. 1.

FIG. 4 is a structure schematic of a coil of the present disclosure.

In the figures, 100 denotes sound device, 1 denotes frame, 2 denotes vibration system, 21 denotes diaphragm, 211 denotes fixing part, 212 denotes folded ring part, 213 denotes dome, 22 denotes coil, 221 denotes first coil, 222 denotes second coil, 3 denotes magnetic system, 31 denotes magnetic bowl, 311 denotes breathable hole, 32 denotes main magnet, 321 denotes first main magnet, 322 denotes second main magnet, 33 denotes sub-magnet, 331 denotes first sub-magnet, 332 denotes second sub-magnet, 333 denotes third sub-magnet, 334 denotes fourth sub-magnet, 34 denotes magnetic gap, 35 denotes magnetic guide plate, 4 denotes conductive member, 5 denotes pole core, 6 denotes breathable isolator.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

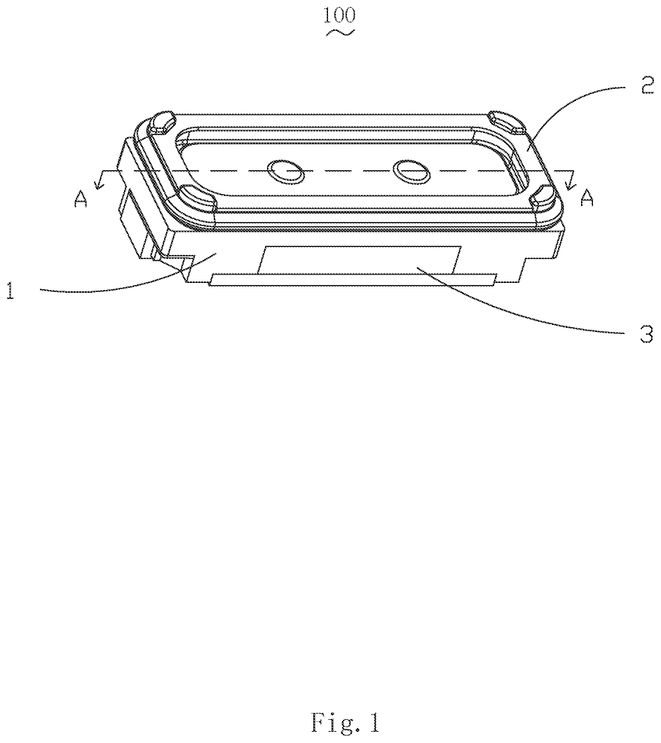

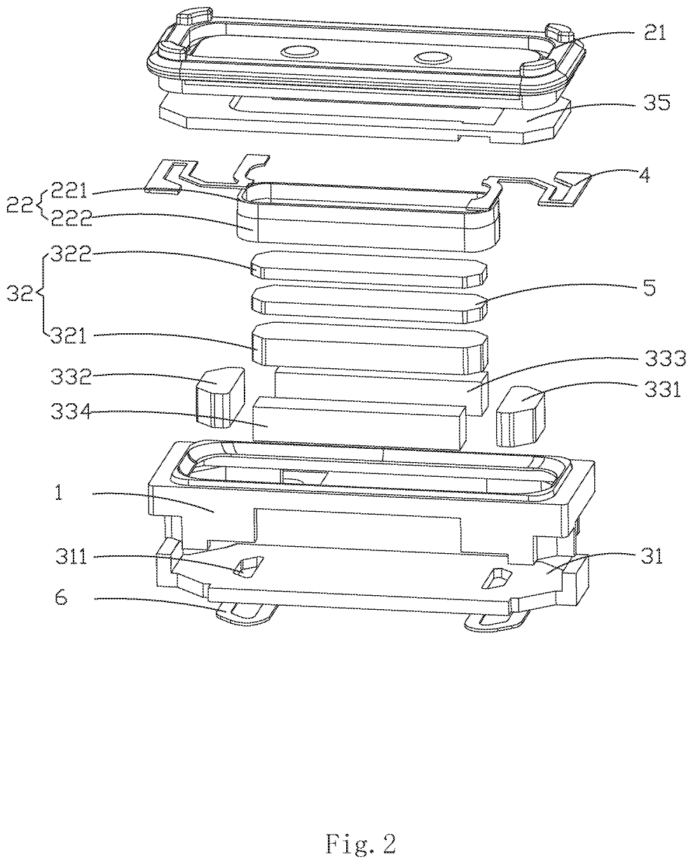

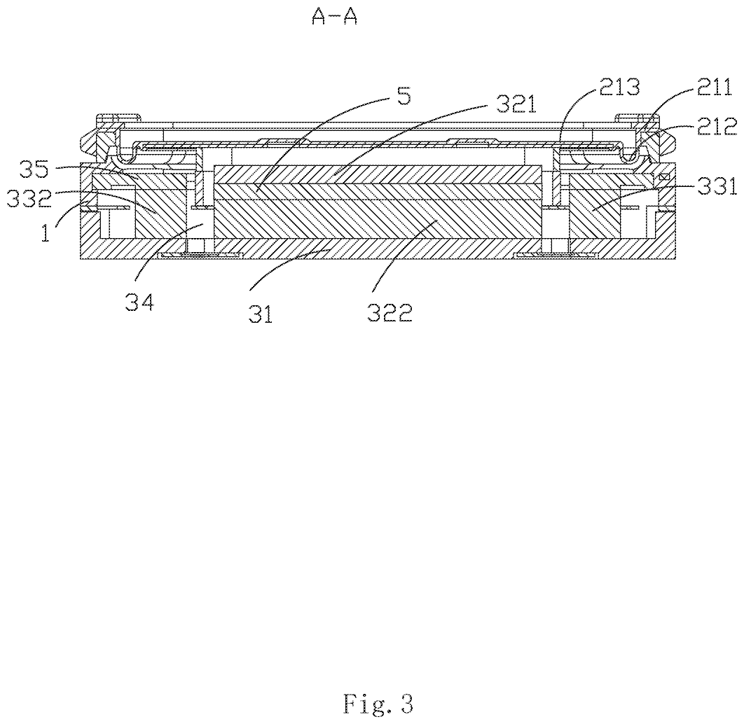

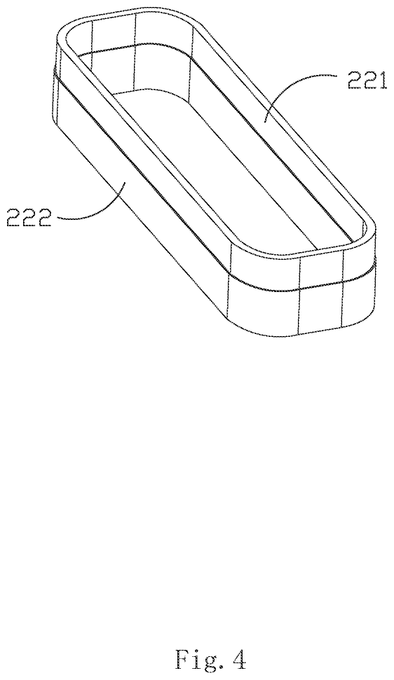

Please refer to FIGS. 1-4 together, a sound device 100 provided by an exemplary embodiment of the present disclosure includes a frame 1, a vibration system 2 and a magnetic system 3.

The magnetic system 3 comprises a magnetic bowl 31 fixed to the frame 1 and a main magnet 32 and a sub-magnet 33 housed in the magnetic bowl 31. The main magnet 32 being spaced apart from the sub-magnet 33 to form a magnetic gap 34. In one possible embodiment the sub-magnet 33 further comprising a first sub-magnet 331, a second sub-magnet 332, a third sub-magnet 333 and a fourth sub-magnet 334. the first sub-magnet 331, the second sub-magnet 332, the third sub-magnet 333 and the fourth sub-magnet 334 being provided at intervals around the main magnet 32 to form the magnetic gap 34.

Wherein the first sub-magnet 331 and the second sub-magnet 332 are covered with magnetic guide plate 35, the magnetic guide plate 35 is fixed to the frame 1.

The magnetic bowl 31 is also provided with a breathable hole 311, breathable isolator 6 covers the breathable hole 311.

Specifically, the main magnet 32 further comprises a first main magnet 321 and a second main magnet 322, with a pole core 5 sandwiched between the first main magnet 321 and the second main magnet 322.

The vibration system 2 includes a diaphragm 21 fixed to the frame 1 and a coil 22 driving the diaphragm 21 for sound generation, the coil 22 is at least partially inserted in the magnetic gap 34.

The coil 22 includes a first coil 221 and a second coil 222, one end of the first coil 221 is fixed to the side of the diaphragm 21 near the magnetic system 3, one end of the second coil 222 is fixed to the end of the first coil 221 near the magnetic system 3, and the first coil 221 and the second coil 222 are insulated from each other.

The diaphragm 21 also includes a ring-shaped fixing part 211 fixed to the frame 1, a folded ring part 212 fixed to the inner periphery of the fixing part 211, and a dome 213 fixed to the inner periphery of the folded ring part 212. the first coil 221 is fixed to the side of the dome 213 facing the magnetic system 3.

Specifically, in this embodiment, the coil 22 is formed by continuous winding of energized wires, the coil 22 as a whole is a hollow circle-shaped structure and has a height. The coil 22 is inserted in the magnetic gap 34, the conductive member 4 is electrically connected to the coil 22, the conductive member 2 and the coil 22 is energized to drive the diaphragm 21 through electromagnetic reaction to achieve the sound effect, preferably, the conductive member 4 is FPC.

The first coil 221 and the second coil 222 are wound in one piece to form a structure.

The second coil 222 continues to be coaxially wound at the end of the first coil 221, so that the first coil 221 acts as a coil bracket, and the second coil 222 continues to be wound on the bracket structure formed by the first coil 221. In the entire coil 22 structure, the second coil 222 is used to energize the drive, at this point the wires of the first coil 221 and the wires of the second coil 222 are insulated from each other.

The projection of the second coil 222 in the plane parallel to the vibration direction of the diaphragm 21 is covered by the projection of the main magnet 32 in the plane parallel to the vibration direction of the diaphragm 21, allowing the second coil 222 to be adjusted in a certain position within the magnetic gap 34, specifically, the length of the second coil 222 inserted in the magnetic gap 34 can be adjusted by means of controlling the number of turns of the first coil 221 during winding.

Specifically, the coil 22 forms an electromagnetic field through a structure inserted in the magnetic gap 34, and in this embodiment, the first coil 221 is connected to the diaphragm 21, while the second coil 222 is connected to the first coil 221, equivalent to the first coil 221 acting as a support structure between the second coil 222 and the diaphragm 21. At this time, adjusting the winding height of the first coil 221 according to the position of the magnetic gap 34, the overall position of the second coil 222 in the magnetic gap 34 can be adjusted so as to maximize the BL of the second coil 222 in the magnetic system 3.

Preferably, the thickness of the first coil 221 is less than the thickness of the second coil 222 along a direction perpendicular to the vibration direction of the diaphragm 21.

Specifically, in this embodiment, the first coil 221 only serves as a support structure for the second coil 222, and the only structure in the voice coil 22 that is used to energize the diaphragm to produce a driving effect during the entire sound generation of the sound device 100 is the second coil 222, therefore, the width of the second coil 222 is increased to enhance the acoustic effect.

Compared with related technology, the coil 22 in the sound device 100 of the present disclosure includes a first coil 221 and a second coil 222, both in the shape of a ring, one end of the first coil 221 is fixed to the side of the diaphragm 21 near the magnetic circuit system 3, and the second coil 222 is fixed to the end of the first coil 221 near the magnetic circuit system 3, and the first coil 221 and the second coil 222 are insulated from each other. By using the first coil 221 as a support design for the second coil 222 in place of the conventional bracket structure to facilitate the adjustment of the position of the second coil 222 in the magnetic gap 34 along the vibration direction of the diaphragm by flexibly adjusting the number of turns of the first coil 221, the BL of second coil 222 is maximized in the magnetic circuit, effectively enhancing the acoustic performance.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A sound device comprising:
a frame;
a vibration system supported on the frame;
a magnetic system driving the vibration system for sound generation supported on the frame;
the magnetic system comprises a main magnet, a sub-magnet and a magnetic gap formed by spacing of the main magnet and the sub-magnet;
the vibration system includes a diaphragm fixed to the frame and a coil driving the diaphragm for sound generation, the coil is at least partially inserted in the magnetic gap;
the coil includes a first coil and a second coil both in a shape of ring, one end of the first coil is fixed to the side of the diaphragm near the magnetic system, one end of the second coil is fixed to the end of the first coil near the magnetic system, and the first coil and the second coil are insulated from each other.

2. The sound device as described in claim 1, wherein the first coil and the second coil are wound in one piece to form a structure.

3. The sound device as described in claim 2, wherein the second coil is formed by continuing coaxial winding at the end of the first coil.

4. The sound device as described in claim 1, wherein a projection of the second coil in the plane parallel to a vibration direction of the diaphragm is covered by a projection of the main magnet in the plane parallel to the vibration direction of the diaphragm.

5. The sound device as described in claim 1, wherein a thickness of the first coil is less than a thickness of the second coil along a direction perpendicular to the vibration direction of the diaphragm.

6. The sound device as described in claim 1, wherein the diaphragm includes a ring-shaped fixing part fixed to the frame, a folded ring part fixed to a inner periphery of the fixing part, and a dome fixed to a inner periphery of the folded ring part, the first coil is fixed to the side of the dome facing the magnetic system.

7. The sound device as described in claim 1, wherein the sound device comprises a breathable isolator, the magnetic system comprises a magnetic bowl; the magnetic bowl comprises a breathable hole, the breathable isolator covers the breathable hole.

8. The sound device as described in claim 7, wherein the main magnet and the sub-magnet are fixed to the magnetic bowl.
